(19) United States
(12) Patent Application Publication
(10) Pub. No.: US 2026/0279087 A1
(43) Pub. Date: Sep. 17, 2026

(54) APPARATUS AND METHOD FOR ADAPTIVE DATA STRUCTURE GENERATION

(71) Applicant: Mary Street Group Enterprises, Inc., Cheyenne, WY (US)

(72) Inventors: Scott Akerley, Westlake Village, CA (US); Ryan Akerley, Westlake Village, CA (US); Richard Lomas, Oak Park, CA (US)

(73) Assignee: Mary Street Group Enterprises, Inc., Cheyenne, WY (US)

(21) Appl. No.: 19/076,194

(22) Filed: Mar. 11, 2025

(51) Int. Cl. G06V 30/148; G06F 16/951; G06V 30/19

(52) U.S. Cl. CPC G06V 30/153; G06F 16/951; G06V 30/19173

(57) ABSTRACT

An apparatus and method for adaptive data structure generation are disclosed. The apparatus includes at least a processor and a memory communicatively connected to the at least a processor, wherein the memory contains instructions configuring the at least a processor to receive a plurality of data sets from one or more data sources, extract key data points from the plurality of data sets, classify the plurality of data sets into one or more data point groups as a function of the key data points, generate an adaptive data structure as a function of the one or more data point groups, generate an interactive user interface displaying the adaptive data structure and update the adaptive data structure as a function of a user input.

### FIELD OF THE INVENTION

The present invention generally relates to the field of data structure generation. In particular, the present invention is directed to an apparatus and method for adaptive data structure generation.

### BACKGROUND

The organization and management of data have become increasingly critical as the volume and complexity of data generated by digital systems continue to grow. Traditional methods of data structuring often rely on static schemas or rigid database architectures, which may not adequately address the dynamic nature of data sources or the evolving needs of users. Existing systems cannot efficiently generate adaptive data structures.

### SUMMARY OF THE DISCLOSURE

In an aspect, an apparatus for adaptive data structure generation is disclosed. The apparatus includes at least a processor and a memory communicatively connected to the at least a processor, wherein the memory contains instructions configuring the at least a processor to receive a plurality of data sets from one or more data sources, extract key data points from the plurality of data sets, wherein extracting the key data points includes generating natural language training data including industry verbiages, training a natural language processing module using the natural language training data and extracting the key data points using the trained natural language processing module, classify the plurality of data sets into one or more data point groups as a function of the key data points, generate an adaptive data structure as a function of the one or more data point groups, generate an interactive user interface displaying the adaptive data structure, wherein the interactive user interface includes one or more event handlers, wherein the one or more event handlers are configured to receive a user input through a user input field and update the adaptive data structure as a function of the user input.

In another aspect, a method for adaptive data structure generation is disclosed. The method includes receiving, using at least a processor, a plurality of data sets from one or more data sources, extracting, using the at least a processor, key data points from the plurality of data sets, wherein extracting the key data points includes generating natural language training data including industry verbiages, training a natural language processing module using the natural language training data and extracting the key data points using the trained natural language processing module, classifying, using the at least a processor, the plurality of data sets into one or more data point groups as a function of the key data points, generating, using the at least a processor, an adaptive data structure as a function of the one or more data point groups, generating, using the at least a processor, an interactive user interface displaying the adaptive data structure, wherein the interactive user interface includes one or more event handlers, wherein the one or more event handlers are configured to receive a user input through a user input field and updating, using the at least a processor, the adaptive data structure as a function of the user input.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus for adaptive data structure generation;

FIGS. 2A-C illustrates an exemplary adaptive data structure;

FIG. 3 illustrates a block diagram of an exemplary machine-learning module;

FIG. 4 illustrates a diagram of an exemplary neural network;

FIG. 5 illustrates a block diagram of an exemplary node in a neural network;

FIG. 6 illustrates a flow diagram of an exemplary method for adaptive data structure generation; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for adaptive data structure generation are disclosed. The apparatus includes at least a processor and a memory communicatively connected to the at least a processor, wherein the memory contains instructions configuring the at least a processor to receive a plurality of data sets from one or more data sources, extract key data points from the plurality of data sets, wherein extracting the key data points includes generating natural language training data including industry verbiages, training a natural language processing module using the natural language training data and extracting the key data points using the trained natural language processing module, classify the plurality of data sets into one or more data point groups as a function of the key data points, generate an adaptive data structure as a function of the one or more data point groups, generate an interactive user interface displaying the adaptive data structure, wherein the interactive user interface includes one or more event handlers, wherein the one or more event handlers are configured to receive a user input through a user input field and update the adaptive data structure as a function of the user input.

Automating the property verification process for underwriting and claims may significantly reduce time and labor costs, while improving the accuracy of risk assessment.

Real estate agents and property investors may use the apparatus to instantly access comprehensive property data, including renovation histories and potential legal issues like liens or encumbrances.

Homeowners looking to validate renovation history or provide proof of upgrades to insurers may benefit from quick access to all relevant records in one place.

Exemplary embodiments illustrating aspects of the present disclosure are described below in the context of several specific examples.

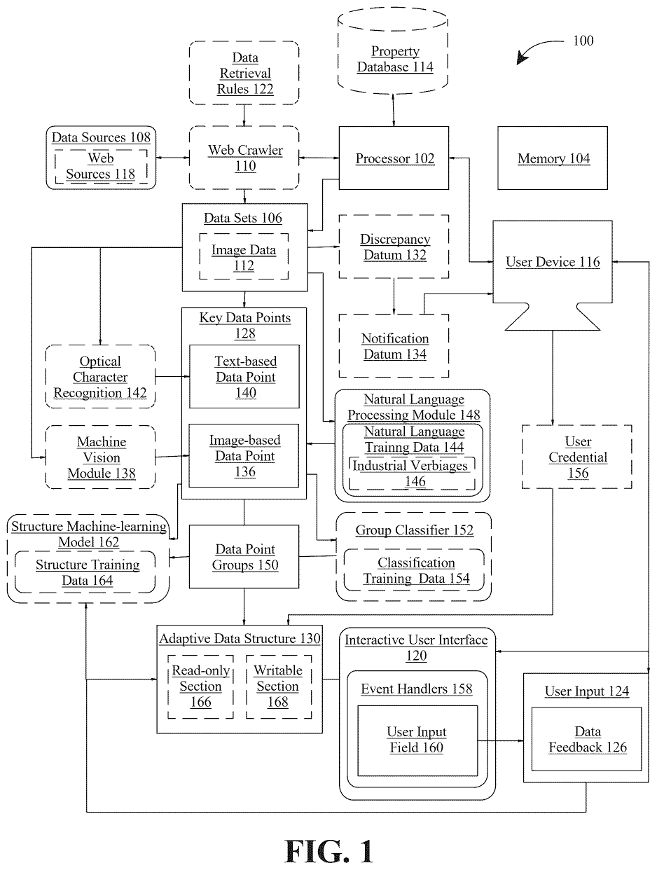

Referring now to FIG. 1, an exemplary embodiment of an apparatus 100 for adaptive data structure generation is illustrated. Apparatus 100 includes at least a processor 102. Processor 102 may include, without limitation, any processor described in this disclosure. Processor 102 may be included in a computing device. Processor 102 may include any computing device as described in this disclosure, including without limitation a microcontroller, microprocessor, digital signal processor (DSP) and/or system on a chip (SoC) as described in this disclosure. Processor 102 may include, be included in, and/or communicate with a mobile device such as a mobile telephone or smartphone. Processor 102 may include a single computing device operating independently, or may include two or more computing device operating in concert, in parallel, sequentially or the like; two or more computing devices may be included together in a single computing device or in two or more computing devices. Processor 102 may interface or communicate with one or more additional devices as described below in further detail via a network interface device. Network interface device may be utilized for connecting processor 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more computing tasks as described below across a plurality of computing devices of computing device, which may operate in parallel, in series, redundantly, or in any other manner used for distribution of tasks or memory between computing devices. Processor 102 may be implemented, as a non-limiting example, using a “shared nothing” architecture.

With continued reference to FIG. 1, processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 102 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 104 communicatively connected to processor 102. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other property for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 104 contains instructions configuring processor 102 to receive a plurality of data sets 106 from one or more data sources 108. For the purposes of this disclosure, “data set” is data associated with a property that is input into an apparatus 100. In some embodiments, data set 106 may include various formats, including texts, images, audio, video, unstructured data or structured data. As a non-limiting example, data set 106 may be extracted by web crawler 110 may come in unstructured formats from permits, renovation records, and inspection reports. For example, and without limitation, data set 106 may include permit summaries and renovation logs. In some embodiments, data set 106 may include image data 112. For the purposes of this disclosure, “image data” is digital representations of visual information. As a non-limiting example, image data 112 may include images of properties, document, and the like.

With continued reference to FIG. 1, in some embodiments, data set 106 may include information related to a property. For the purposes of this disclosure, a “property” is a physical location or building. As a non-limiting example, data set 106 may include information related to residential and commercial properties. For example, and without limitation, data set 106 may include information such as property addresses, geographic coordinates, ownership details, historical transaction records, tax assessments, zoning classifications, building specifications, and current market valuations. As another non-limiting example, data set 106 may include metadata related to the property, such as photographs (image data 112), floor plans, environmental assessments, and neighborhood demographics. In some embodiments, data set 106 may include temporal data. As a non-limiting example, temporal data may include historical price trends, renovation timelines, or records of maintenance activities. In some embodiments, data set 106 may include qualitative data. As a non-limiting example, qualitative data may include user-generated reviews, descriptions from real estate listings, or sentiment analysis derived from related online sources. In some embodiments, data set 106 may include satellite imagery, transportation accessibility metrics, utility service information, or climate risk assessments.

With continued reference to FIG. 1, for the purposes of this disclosure, a “data source” is an origin or repository from which data is obtained. As a non-limiting example, data source 108 may include property database 114, web crawler 110, user device 116, application programming interfaces (APIs), external databases, and the like. In some embodiments, apparatus 100 may include a property database 114. As used in this disclosure, “property database” is a data structure configured to store data related to data set. In one or more embodiments, property database 114 may include inputted or calculated information and datum related to data set 106. In some embodiments, a datum history may be stored in property database 114. As a non-limiting example, the datum history may include real-time and/or previous inputted data related to data set 106. As a non-limiting example, property database 114 may include instructions from a user, who may be an expert user, a past user in embodiments disclosed herein, or the like, where the instructions may include examples of the data related to data set 106. In some embodiments, processor 102 may retrieve data set 106 from external databases. As a non-limiting example, external database may include tax assessor and county records, public records repositories for liens and encumbrances, and the like.

With continued reference to FIG. 1, in some embodiments, processor 102 may be communicatively connected with property database 114 or any database disclosed in this disclosure. For example, and without limitation, in some cases, property database 114 may be local to processor 102. In another example, and without limitation, property database 114 may be remote to processor 102 and communicative with processor 102 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 102 connect directly, dynamically, and non-hierarchically to as many other computing devices as possible. A “network topology” as used in this disclosure is an arrangement of elements of a communication network. The network may use an immutable sequential listing to securely store property database 114. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, property database 114 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, data set 106 may be derived from a web crawler 110. A “web crawler,” as used herein, is a program that systematically browses the internet for the purpose of Web indexing. The web crawler 110 may be seeded with platform URLs, wherein the crawler may then visit the next related URL, retrieve the content, index the content, and/or measures the relevance of the content to the topic of interest. In some embodiments, processor 102 may generate web crawler 110 to scrape data set 106 from web sources 118. For the purposes of this disclosure, a “web source” is any internet-based location or online resource that hosts or provides access to data. A web source 118 may include, but is not limited to, websites, web pages, online databases, public or private APIs, social media platforms, forums, blogs, and news websites. For example, and without limitation, web source 118 may include real estate platforms, local government property and building permit websites, and the like. In some embodiments, processor 102 may retrieve data set 106 from web sources 118 using a web crawler 110. The web crawler 110 may be seeded and/or trained with a reputable website to begin the search. Web crawler 110 may be generated by processor 102. In some embodiments, web crawler 110 may be trained with information received from user through an interactive user interface 120. The interactive user interface 120 disclosed herein is further described in detail below. In some embodiments, web crawler 110 may be configured to generate a web query. A web query may include search criteria received from user. For example, user may submit a plurality of websites for web crawler 110 to search to data set 106. Additionally, web crawler 110 function may be configured to search for and/or detect one or more data patterns. A “data pattern” as used in this disclosure is any repeating forms of information. In some embodiments, web crawler 110 may be configured to determine the relevancy of a data pattern. Relevancy may be determined by a relevancy score. A relevancy score may be automatically generated by processor 102, received from a machine learning model, and/or received from user. In some embodiments, a relevancy score may include a range of numerical values that may correspond to a relevancy strength of data received from a web crawler 110 function. As a non-limiting example, a web crawler 110 function may search the Internet for data set 106. In some embodiments, web crawler 110 may be designed to access multiple websites (web sources 118) simultaneously, gather structured and unstructured data (data sets 106), and may process it for downstream analysis. In some embodiments, processor 102 may bypass basic anti-bot mechanisms, may handle dynamic web content, and may extract key details relevant to a target property.

With continued reference to FIG. 1, in some embodiments, web crawler 110 may be configured to retrieve a plurality of data sets 106 from one or more web sources 118 as a function of data retrieval rules 122. For the purposes of this disclosure, a “data retrieval rule” is a guideline or parameter that determines a scope, depth, and manner of data collection by a web crawler. As a non-limiting example, data retrieval rule 122 may include specifications regarding types of data to be retrieved, such as text content, metadata, images, or file attachments. As a non-limiting example, data retrieval rule 122 may include constraints on the web crawler's behavior. For example, and without limitation, data retrieval rule 122 may include a guideline limiting data retrieval to specific domains, subdomains, or page types, or excluding certain URLs based on keywords or patterns. In some embodiments, data retrieval rule 122 may include temporal parameters. For example, and without limitation, data retrieval rule 122 may include a guideline specifying a frequency of data collection (e.g., hourly, daily, or weekly) or targeting content that has been updated or created within a particular time frame. For instance, and without limitation, web crawler 110 may be configured to retrieve only newly published property listings or recently updated zoning information. In some embodiments, data retrieval rule 122 may incorporate prioritization logic. As a non-limiting example, data retrieval rule 122 may assign higher importance to certain web sources or data types. For example, and without limitation, web crawler 110 may prioritize retrieving property tax records from government databases over user-generated content from public forums. In some embodiments, data retrieval rule 122 may include compliance guidelines to ensure ethical and lawful data retrieval. For example, and without limitation, data retrieval rule 122 may require web crawler 110 to adhere to restrictions outlined in a website's robots.txt file, respect rate-limiting protocols, or authenticate access using API keys or tokens provided by authorized web sources. In some embodiments, data retrieval rule 122 may include advanced filtering and processing conditions. For example, and without limitation, data retrieval rule 122 may include extracting only structured data elements (e.g., tables or JSON objects) or transforming unstructured data (e.g., HTML content) into a predefined format compatible with data set 106.

With continued reference to FIG. 1, for the purposes of this disclosure, a “user device” is any device a user may use to input data. As a non-limiting example, user device 116 may include a laptop, desktop, tablet, mobile phone, smart phone, smart watch, kiosk, screen, smart headset, or things of the like. In some embodiments, user device 116 may include an interface configured to receive inputs from a user. In some embodiments, user may manually input any data into apparatus 100 using user device 116. In some embodiments, user may have a capability to process, store or transmit any information independently. As a non-limiting example, user may manually input data set 106. For the purposes of this disclosure, a “user” is any individual or organization that uses an apparatus 100. As a non-limiting example, user may include an insurance agent, homeowner, real estate investor, and the like.

With continued reference to FIG. 1, in some embodiments, receiving a plurality of data sets 106 may include updating data retrieval rules 122 as a function of user input 124, wherein the user input 124 may include data feedback 126 and retrieving the plurality of data sets 106 using web crawler 110 as a function of the updated data retrieval rules 122. For the purposes of this disclosure, “data feedback” is information provided by a user that reflects quality, relevance, or accuracy of previously retrieved data. As a non-limiting example, data feedback 126 may include explicit user evaluations: for instance, ratings, comments, or corrections. As a non-limiting example, data feedback 126 may include implicit indicators: for instance, user actions like selecting, dismissing, or favoriting specific key data points 128 within adaptive data structure 130. For the purposes of this disclosure, an “adaptive data structure” is a structured organization of data related to a property that adapts through interactions by users. The adaptive data structure 130 disclosed herein is further described below. In some embodiments, data feedback 126 may be used to refine or adjust data retrieval rules 122 to better align with user preferences or objectives. For instance, and without limitation, if a user provides feedback indicating that certain key data points 128 are irrelevant or outdated, data retrieval rules 122 may be updated to exclude specific sources or prioritize more recent data. In a non-limiting example, data feedback 126 may include user-inputted comments specifying that a particular property's market valuation is incorrect or incomplete, then updated data retrieval rules 122 may instruct web crawler 110 to re-prioritize data from more authoritative or frequently updated sources. In other embodiments, data feedback 126 may include system-generated metrics: for instance, click-through rates, time spent viewing specific data points, or interaction patterns. For example, and without limitation, if users consistently interact with first key data point or first data set but rarely view second key data point or second data set, processor 102 may update data retrieval rules 122 to prioritize the first key data point or first data set in future retrieval operations.

With continued reference to FIG. 1, in some embodiments, receiving a plurality of data sets 106 may include identifying a discrepancy datum 132 in the plurality of data sets 106 and generating a notification datum 134 as a function of the discrepancy datum 132. For the purposes of this disclosure, a “discrepancy datum” is a data element indicating values within a plurality of data sets 106 that is inconsistent, conflicting, or deviates from expected values or predefined criteria. As a non-limiting example, discrepancy datum 132 may include mismatched values, missing information, anomalies in data formatting, or inaccuracies identified through validation checks or comparisons with authoritative datasets. For example, and without limitation, discrepancy datum 132 may include a property address listed with different ZIP codes in two sources, a transaction record with a date that precedes the property's construction year, or an unusually low market valuation inconsistent with comparable properties in the same region. For the purposes of this disclosure, a “notification datum” is a data element to inform a user about a discrepancy datum. In a non-limiting example, notification datum 134 may include specific key data points 128 in question, the source of the discrepancy, suggested corrective actions, or links to additional resources for resolving the issue. For example, and without limitation, notification datum 134 may indicate, “Discrepancy identified: Property at 123 Main Street has conflicting transaction dates. Source A lists sale date as 01/15/2020, while Source B lists it as 03/10/2020. Review required.” In some embodiments, notification datum 134 may be transmitted through various communication channels: for instance, displaying an alert within an interactive user interface 120, sending an email to an administrator, or logging the issue for automated resolution.

With continued reference to FIG. 1, in some embodiments, processor 102 may detect discrepancy datum 132 from data set 102 using a machine-learning model to encode representations of the data set 102 and calculate a distance metric between the encoded representations. For the purposes of this disclosure, a “distance metric” is a mathematical measure that quantifies the similarity or difference between two encoded data representations in a multidimensional feature space. As a non-limiting example, distance metric may include cosine similarity, Euclidean distance, Manhattan distance, and the like. In some embodiments, processor 102 may generate encoded representation of data set 106 or key data points 128 using natural language processing module 148 or a classifier (e.g., group classifier 152). In some embodiments, processor 102 may calculate a distance metric between the encoded representations of the data set 106 or key data points 128. A significant distance may indicate a discrepancy datum 132, such as conflicting information or outlier values. For instance, if the ML model encodes two property addresses and the calculated distance metric exceeds a predefined threshold, the processor 102 may flag the data points as potentially inconsistent.

With continued reference to FIG. 1, in some embodiments, processor 102 may interface with an application programming interface (API) of a third-party to identify discrepancy datum 132. For the purposes of this disclosure, an “application programming interface” is a set of protocols, routines, and tools that allow software systems to interact and exchange information with external services or platforms. In a non-limiting example, processor 102 may send a query to an external API to data sets 106 and the API may respond with data (discrepancy datum 132) indicating whether the data set 106 is valid, standardized, or associated with additional metadata.

With continued reference to FIG. 1, in some embodiments, web sources 118 may employ Completely Automated Public Turing test to tell Computers and Humans Apart (CAPTCHA) or other anti-bot measures. In some embodiments, processor 102 may integrate CAPTCHA-solving mechanisms or request application programming interface (API) access. In some embodiments, processor 102 may scrape data from public websites to ensure compliance with terms of service and data protection laws, such as California Consumer Privacy Act (CCPA) and the General Data Protection Regulation (GDPR).

With continued reference to FIG. 1, memory 104 contains instructions configuring processor 102 to extract key data points 128 from data set 106. For the purposes of this disclosure, a “key data point” is a characteristic of a data set. As a non-limiting example, key data points 128 may include textual information, such as names, dates, addresses, identification numbers, medical terms, keywords, or labels. For example, and without limitation, an image of a document (image data 112) may contain key data points 128 like detected words, paragraphs, table structures, or logos. As another non-limiting example, key data points 128 may include numerical values, such as prices, measurements, quantities, coordinates, or time stamps. As another non-limiting example, key data points 128 may include visual features, such as shapes, colors, patterns, edges, or the like. For example, and without limitation, key data points 128 may include dates and details of renovations, building and electrical permits, zoning changes, historical sales and property listings, and the like. For example, and without limitation, key data points 128 may include information related to fire, flood, noise, walk ability of properties, and the like. Examples of key data points 128 described herein are mere examples and persons skilled in the art, upon reviewing the entirety of this disclosure, may appreciate various key data points 128 that can be extracted from data set 106. In some embodiments, key data points 128 may be stored in property database 114 and processor 102 may retrieve key data points 128 from property database 114. In some embodiments, user may manually input key data points 128.

With continued reference FIG. 1, in some embodiments, extracting key data points 128 may include extracting image-based data point 136 of key data points 128 from image data 112 of data set 106 using a machine vision module 138 and converting the image-based data point 136 into machine-readable data. For the purposes of this disclosure, an “image-based data point” is a feature, property, or data point that is extracted from image data. As a non-limiting example, image-based data point 136 may include patterns, edges, contours, shapes, textures, and the like. For example, and without limitation, image-based data point 136 may include coordinates or relative location of properties in an image of a property. For example, and without limitation, image-based data point 136 may include an outline or footprint of a property in a document of property layout. For example, and without limitation, image-based data point may include exterior details of a property. For the purposes of this disclosure, “machine-readable data” is data that is structured and formatted in a way that can be processed, interpreted, and used by a computer. As a non-limiting example, machine-readable data may include various formats, such as JSON, XML, CSV, binary formats, and the like.

With continued reference to FIG. 1, in some embodiments, processor 102 may be configured to analyze data set 106 using machine vision module 138 to extract image-based data point 136. For the purposes of this disclosure, a “machine vision module” is a type of technology that enables a computing device to inspect, evaluate and identify still or moving images. For example, in some cases a machine vision module 138 may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, a machine vision process may operate image classification and segmentation models, such as without limitation by way of machine vision resource (e.g., OpenMV or TensorFlow Lite). A machine vision process may detect motion, for example by way of frame differencing algorithms. A machine vision process may detect markers, for example blob detection, object detection, face detection, and the like. In some cases, a machine vision process may perform eye tracking (i.e., gaze estimation). In some cases, a machine vision process may perform person detection, for example by way of a trained machine learning model. In some cases, a machine vision process may perform motion detection (e.g., camera motion and/or object motion), for example by way of optical flow detection. In some cases, machine vision process may perform code (e.g., barcode) detection and decoding. In some cases, a machine vision process may additionally perform image capture and/or video recording.

With continued reference to FIG. 1, in some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and φ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level.

With continued reference to FIG. 1, alternatively or additionally, identifying image-based data point 136 may include classifying the shape of the image-based data point 136 to a label of the image-based data point 136 using an image classifier; the image classifier may be trained using a plurality of images and labels of image-based data point 136. The image classifier may be configured to determine which of a plurality of edge-detected shapes is closest to an image-based data point 136 as determined by training using training data and selecting the determined shape as the image-based data point 136. As a non-limiting example, the image classifier may be trained with image training data that correlates the plurality of images of image-based data point 136 to a label of the image-based data point 136. Alternatively, identification of the image-based data point 136 may be performed without using computer vision and/or classification; for instance, identifying the image-based data point 136 may further include receiving, from a user, an identification of the image-based data point 136 in an image (image data 112).

With continued reference FIG. 1, in some embodiments, extracting key data points 128 may include extracting text-based data point 140 of the key data points 128 from image data 112 of data set 106 using an optical character recognition. For the purposes of this disclosure, a “text-based data point” is a characteristic that consists of text. As a non-limiting example, text-based data point 140 may include textual information, such as names, dates, addresses, identification numbers, medical terms, keywords, or labels. For example, and without limitation, an image of a document (image data 112) may contain at text-based data point 140 like detected words, paragraphs, table structures, or logos. As another non-limiting example, text-based data point 140 may include numerical values, such as prices, measurements, quantities, coordinates, or time stamps.

With continued reference to FIG. 1, in some embodiments, processor 102 may analyze data set 106 (e.g., image data 112) to find text-based data point 140 using optical character recognition (OCR) 142. For the purposes of this disclosure, “optical character recognition” is a technology that enables the recognition and conversion of printed or written text into machine-encoded text. In some cases, the at least a processor 102 may be configured to recognize a keyword using the OCR 142 to find text-based data point 140. As used in this disclosure, a “keyword” is an element of word or syntax used to identify and/or match elements to each other. In some cases, the at least a processor 102 may transcribe much or even substantially all data set 106.

With continued reference to FIG. 1, in some embodiments, optical character recognition or optical character reader (OCR) 142 may include automatic conversion of images of written (e.g., typed, handwritten or printed text) into machine-encoded text. In some cases, recognition of a keyword from data set 106 may include one or more processes, including without limitation optical character recognition (OCR) 142, optical word recognition, intelligent character recognition, intelligent word recognition, and the like. In some cases, OCR 142 may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine-learning processes. In some cases, intelligent word recognition (IWR) may recognize written text, one word at a time, for instance by employing machine-learning processes.

With continued reference to FIG. 1, in some cases, OCR 142 may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information may make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of data set 106. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the data set 106 to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process may include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

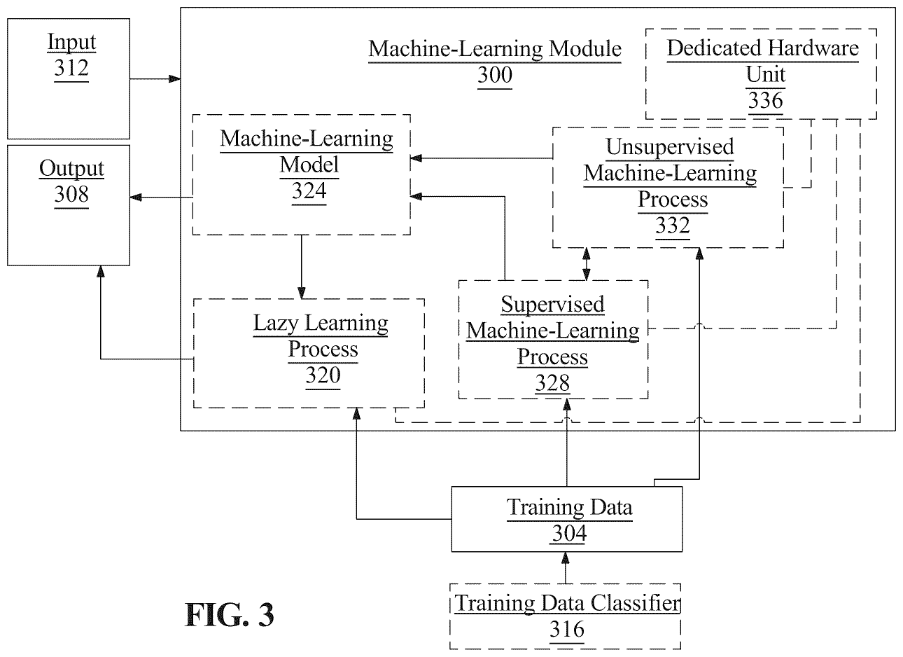

With continued reference to FIG. 1, in some embodiments, an OCR process may include a feature extraction process. In some cases, feature extraction may decompose a glyph into a feature. Exemplary non-limiting features may include corners, edges, lines, closed loops, line direction, line intersections, and the like. In some cases, feature extraction may reduce dimensionality of representation and may make the recognition process computationally more efficient. In some cases, extracted feature may be compared with an abstract vector-like representation of a character, which might reduce to one or more glyph prototypes. General techniques of feature detection in computer vision are applicable to this type of OCR 142. In some embodiments, machine-learning processes like nearest neighbor classifiers (e.g., k-nearest neighbors algorithm) may be used to compare image features with stored glyph features and choose a nearest match. OCR 142 may employ any machine-learning process described in this disclosure, for example machine-learning processes described with reference to FIG. 3. Exemplary non-limiting OCR software may include Cuneiform and Tesseract. Cuneiform may include a multi-language, open-source optical character recognition system originally developed by Cognitive Technologies of Moscow, Russia. Tesseract may include free OCR software originally developed by Hewlett-Packard of Palo Alto, California, United States.

With continued reference to FIG. 1, in some cases, OCR 142 may employ a two-pass approach to character recognition. A first pass may try to recognize a character. Each character that is satisfactory may be passed to an adaptive classifier as training data. The adaptive classifier then may get a chance to recognize characters more accurately as it further analyzes data set 106. Since the adaptive classifier may have learned something useful a little too late to recognize characters on the first pass, a second pass may be run over the data set 106. Second pass may include adaptive recognition and use characters recognized with high confidence on the first pass to recognize better remaining characters on the second pass. In some cases, two-pass approach may be advantageous for unusual fonts or low-quality image components where visual verbal content may be distorted. Another exemplary OCR software tool may include OCRopus. OCRopus development is led by German Research Centre for Artificial Intelligence in Kaiserslautern, Germany. In some cases, OCR software may employ neural networks.

With continued reference to FIG. 1, in some cases, OCR 142 may include post-processing. For example, OCR accuracy may be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR 142 post-processing to further optimize results.

With continued reference to FIG. 1, processor 102 is configured to generate natural language training data 144, wherein natural language training data 144 includes industry verbiages 146. For the purposes of this disclosure, “natural language training data” is data containing correlations that a machine-learning process may use to model relationships between data sets and key data points. For the purposes of this disclosure, “industry verbiages” are standardized terms, phrases, expressions, or technical jargon specific to a particular industry or domain. As a non-limiting example, in the real estate industry, industry verbiages 146 may include terms such as “appraisal value,” “zoning restrictions,” “escrow period,” “triple-net lease,” or “comparative market analysis.” In some embodiments, industry verbiages 146 may be extracted from domain-specific text sources. As a non-limiting example, industry verbiages 146 may be extracted from technical manuals, industry reports, regulatory documents, or professional publications. In some embodiments, industry verbiages 146 may also include abbreviations, acronyms, or colloquial terms. As a non-limiting example, industry verbiages 146 may include technical jargon, slang or industry lingo, and the like. In some embodiments, industry verbiages 146 may include synonyms, antonyms, or contextual definitions derived from authoritative sources, enabling natural language processing module 148 to capture nuanced relationships and infer meanings in data sets 106. In a non-limiting example, natural language training data 144 may include correlations between exemplary data set and exemplary key data points. In some embodiments, natural language training data 144 may be stored in property database 114. In some embodiments, natural language training data 144 may be received from one or more users, property database 114, external computing devices, and/or previous iterations of processing. As a non-limiting example, natural language training data 144 may include instructions from a user, who may be an expert user, a past user in embodiments disclosed herein, or the like, which may be stored in memory and/or stored in property database 114, where the instructions may include labeling of training examples. In some embodiments, natural language training data 144 may be updated iteratively on a feedback loop. As a non-limiting example, processor 102 may update natural language training data 144 iteratively through a feedback loop as a function of data set 106, output of machine vision module 138, optical character recognition, or the like.

With continued reference to FIG. 1, processor 102 is configured to generate natural language processing module 148. For the purposes of this disclosure, “natural language processing module” is a machine-learning module that generates key data points. In a non-limiting example, generating natural language processing module 148 may include training, retraining, or fine-tuning natural language processing module 148 using natural language training data 144 or updated natural language training data 144. In some embodiments, natural language processing module 148 may include a technical language processing. In some embodiments, technical language processing may normalize domain-specific language by identifying and replacing synonymous terms, phrases, or abbreviations. Technical language processing can improve the performance of conventional natural language processing and machine-learning models, particularly in fields where jargon and varied terminology are prevalent. In some embodiments, technical language processing can reduce errors in classification, retrieval, or analysis of data sets 106 or key data points 128. In some embodiments, technical language processing can improve model training by creating a more consistent and compact vocabulary, reducing noise in natural language training data 144 and improving convergence during model optimization. Processor 102 is configured to extract key data points 128 from data set 106 using natural language processing module 148 (i.e., trained or updated natural language processing module 148). In some embodiments, generating training data and training machine-learning models may be simultaneous.

With continued reference to FIG. 1, memory 104 contains instructions configuring processor 102 to classify key data points 128 into one or more data point groups 150. For the purposes of this disclosure, a “data point group” is a set of associative key data points. As a non-limiting example, data point groups 150 may be related to information of a property, such as property address, geographic coordinates, ownership details, assessed value, and zoning classification. In another non-limiting example, data point group 150 may be related to financial information, such as revenue, expenses, profit margins, and tax liabilities. In other embodiments, data point groups 150 may be associated with metadata or tags that describe the purpose, origin, or classification logic of the data point groups 150. For example, a data point group 150 labeled “Risk Assessment Factors” might include key data points 128 such as property flood risk, proximity to hazardous sites, and structural integrity ratings. In some embodiments, processor 102 may enable operations on data point groups 150: for instance, aggregating values, applying filters, or performing cross-group comparisons. For example, and without limitation, a user may compare the average assessed value of properties in two different geographical regions by accessing the respective data point groups 150. In some embodiments, data point group 150 may be stored in property database 114 and processor 102 may retrieve data point group 150 from property database 114.

With continued reference to FIG. 1, in some embodiments, data point groups 150 may be dynamically created or adjusted based on user-defined criteria or machine-learning-driven clustering algorithms (group classifier 152). For instance, and without limitation, processor 102 may identify patterns in data sets 106 or key data points 128 and may create data point groups 150 such as “properties with high market value” or “transactions occurring within the last fiscal year.” In some embodiments, classifying key data points 128 may include generating classification training data 154, wherein the classification training data 154 may include exemplary key data points correlated to exemplary data point groups, training a group classifier 152 using the classification training data 154 and classifying key data points 128 using the trained group classifier 152. In some embodiments, classification training data 154 may be stored in property database 114. In some embodiments, classification training data 154 may be received from one or more users, property database 114, external computing devices, and/or previous iterations of processing. As a non-limiting example, classification training data 154 may include instructions from a user, who may be an expert user, a past user in embodiments disclosed herein, or the like, which may be stored in memory and/or stored in property database 114, where the instructions may include labeling of training examples. In some embodiments, classification training data 154 may be updated iteratively on a feedback loop. As a non-limiting example, processor 102 may update classification training data 154 iteratively through a feedback loop as a function of data set 106, image data 112, key data points 128, outputs of machine-learning models described in this disclosure, and the like. In a non-limiting example, generating group classifier 152 may include training, retraining, or fine-tuning group classifier 152 using classification training data 154 or updated classification training data 154. In some embodiments, generating training data and training machine-learning models may be simultaneous.

With continued reference to FIG. 1, in some embodiments, processor 102 may generate at least a prediction related to data sets 104, key data points 128, data point groups 150, and/or the like. As a non-limiting example, prediction may include whether a property may need a construction, repair or home services. In some embodiments, processor 102 may generate prediction using a machine-learning model. The machine-learning model may be any machine-learning model described in this disclosure. In some embodiments, apparatus 100 may incorporate technology to home services or registered health information administrator (RHIA). Interactive user interface and/or adaptive data structure 130 may include prediction.

With continued reference to FIG. 1, memory 104 contains instructions configuring processor 102 to generate an adaptive data structure 130 as a function of data point groups 150. The user input 124 disclosed herein is further described in detail below. In some embodiments, adaptive data structure 130 may include texts, images, graphs, tables, checklists, and the like. In some embodiments, adaptive data structure 130 may dynamically modify its organization or presentation based on user preferences (user input 124), roles (user credential 156), and the like. In a non-limiting example, adaptive data structure 130 may reorder information or change its structure as a function of user input 124. For example, and without limitation, when accessed by a real estate agent, adaptive data structure 130 may prioritize displaying market valuation trends and recent transaction histories, whereas for a property inspector, it may emphasize structural details and maintenance records. In some embodiments, adaptive data structure 130 may include interactive features; for instance, expandable sections, sortable columns, or filterable views. For instance, and without limitation, users may opt to view property details in a tabular format with sortable fields for square footage, price, and construction date, or as a checklist highlighting key compliance and inspection items.

With continued reference to FIG. 1, memory 104 contains instructions configuring processor 102 to generate an interactive user interface 120 displaying adaptive data structure 130. Interactive user interface 120 includes one or more event handlers 158, wherein the one or more event handlers 158 are configured to receive a user input 124 through a user input field 160. For the purposes of this disclosure, an “interactive user interface” is an interface that facilitates engagement between a user and a system. For the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the user interface using a computing device distinct from and communicatively connected to at least a processor 102. For example, a smart phone, smart, tablet, or laptop operated by a user. In an embodiment, user interface may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. As a non-limiting example, an interactive user interface 120 may include graphical elements such as buttons, icons, menus, sliders, or forms, which users can interact with to receive data, input data, modify displayed data, or initiate actions. In some embodiments, an interactive user interface 120 may enable data entry or selection activities. For instance, and without limitation, a user may allow to interact with graphical elements of interactive user interface 120. In some embodiments, interactive user interface 120 may be stored in a database, and a processor 102 may retrieve the interactive user interface 120 from the database. In some embodiments, users may manually customize or configure interactive user interface 120.

With continued reference to FIG. 1, interactive user interface 120 includes one or more event handlers 158. An “event handler” as used in this disclosure is a callback routine that operates asynchronously once an event takes place. Event handlers 158 may include, without limitation, one or more programs to perform one or more actions based on user input 124, such as generating pop-up windows, submitting forms, changing background colors of a webpage, and the like. Event handler 158 is configured to receive a user input 124 through a user input field 160. For the purposes of this disclosure, a “user input” is any data inputted to a processor 102 by a user. As a non-limiting example, user input 124 may include typed text. For example, and without limitation, user input 124 may include a property address, numerical data like a desired price range, or selections such as clicking on a checkbox to filter results by property type (e.g., residential or commercial). In some embodiments, user input 124 may include gestures such as swiping or dragging to rearrange elements, voice commands for querying specific property details, or file uploads containing relevant documents like property appraisals or inspection reports. In some embodiments, user input 124 may include location information provided using a GPS-enabled device or timestamps associated with the interaction. In some embodiments, processor 102 may be configured to validate user input 124 to ensure it complies with predefined formats or criteria. For instance, and without limitation, processor 102 may verify that a typed address matches a recognized format or that a numerical input falls within an acceptable range and if the validation fails, processor 102 may prompt the user with an error message (notification datum 134) or a suggestion to correct the input. Event handlers 158 may be programmed for specific user input, such as, but not limited to, mouse clicks, mouse hovering, touchscreen input, keystrokes, and the like. For instance and without limitation, an event handler 158 may be programmed to generate a pop-up window if a user double clicks on a specific icon. User input 124 may include a manipulation of computer icons, such as, but not limited to, clicking, selecting, dragging and dropping, scrolling, and the like. In some embodiments, user input 124 may include an entry of characters and/or symbols in a user input field 160. A “user input field” as used in this disclosure is a portion of a graphical user interface configured to receive data from an individual. A user input field 160 may include, but is not limited to, text boxes numerical fields, search fields, filtering fields, and the like. In some embodiments, user input 124 may include touch input. Touch input may include, but is not limited to, single taps, double taps, triple taps, long presses, swiping gestures, and the like. One of ordinary skill in the art will appreciate the various ways a user may interact with interactive user interface 120.

With continued reference to FIG. 1, memory 104 contains instructions configuring processor 102 to update adaptive data structure 130 as a function of user input 124. In a non-limiting example, adaptive data structure 130 may reorganize, expand, or filter its content in response to changes or actions performed by a user (user input 124). For example, and without limitation, if user input 124 specifies a request to view properties within a specific price range, processor 102 may update adaptive data structure 130 to filter out properties outside the specified range and reorder the remaining properties by proximity, price, or other relevant key data points 128 in data point groups 150. In some embodiments, an update to adaptive data structure 130 may include dynamically adding new data elements based on user input 124. For instance, and without limitation, if a user selects a specific property, processor 102 may retrieve and integrate additional details (e.g., recent transaction history, nearby amenities, or comparable properties) into adaptive data structure 130. In some embodiments, user input 124 may trigger a reconfiguration of a display format of adaptive data structure 130. For example, and without limitation, if a user requests a graphical representation of data, processor 102 may generate and integrate interactive charts or heatmaps into adaptive data structure 130.

With continued reference to FIG. 1, in some embodiments, processor 102 may use structure machine-learning model 162 to predict and preconfigure or update adaptive data structure 130 most relevant to a user's context. For example, and without limitation, if user input 124 indicates a focus on properties within a specific price range, adaptive data structure 130 may automatically group and highlight relevant key data points 128 while suppressing less pertinent information. In some embodiments, processor 102 may use structure machine-learning model 162 to predict and implement updates to adaptive data structure 130 based on historical user input patterns. For instance, and without limitation, if a user frequently filters properties by square footage, processor 102 may preemptively group properties with similar characteristics or present recommendations aligned with this preference into data point groups 150. In some embodiments, updating adaptive data structure 130 may include generating structure training data 164, wherein the structure training data 164 may include exemplary key data points and exemplary user credentials correlated to exemplary adaptive data structures, training a structure machine-learning model 162 using the structure training data 164 and generating the adaptive data structure 130 using the trained structure machine-learning model 162. In some embodiments, structure training data 164 may be stored in property database 114. In some embodiments, structure training data 164 may be received from one or more users, property database 114, external computing devices, and/or previous iterations of processing. As a non-limiting example, structure training data 164 may include instructions from a user, who may be an expert user, a past user in embodiments disclosed herein, or the like, which may be stored in memory and/or stored in property database 114, where the instructions may include labeling of training examples. In some embodiments, structure training data 164 may be updated iteratively on a feedback loop. As a non-limiting example, processor 102 may update structure training data 164 iteratively through a feedback loop as a function of data set 106, key data points 128, data point groups 150, user input 124, output of any machine-learning models described in this disclosure, or the like. In some embodiments, processor 102 may be configured to generate a structure machine-learning model 162. In a non-limiting example, generating structure machine-learning model 162 may include training, retraining, or fine-tuning structure machine-learning model 162 using structure training data 164 or updated structure training data 164. In some embodiments, processor 102 may be configured to generate adaptive data structure 130 using structure machine-learning model 162 (i.e. trained or updated structure machine-learning model 162). In some embodiments, user may be classified to a user cohort using a cohort classifier. Cohort classifier may be consistent with any classifier discussed in this disclosure. Cohort classifier may be trained on cohort training data, wherein the cohort training data may include user, user credential 156 or data set 106 correlated to user cohorts. In some embodiments, a user may be classified to a user cohort and processor 102 may generate adaptive data structure 130 based on the user cohort using a machine-learning module as described in detail with respect to FIG. 3 and the resulting output may be used to update structure training data 164. In some embodiments, generating training data and training machine-learning models may be simultaneous.

With continued reference to FIG. 1, in some embodiments, updating adaptive data structure 130 may include authenticating user credential 156 of a user and updating the adaptive data structure 130 as a function of the user credential 156 by prioritizing at least a portion of key data points 128 in the adaptive data structure 130. In some embodiments, processor 102 may be configured to receive the user credential 156 associated with users from a user device 116, compare the user credential 156 to an authorized user credential stored within an authentication database, and bypass authentication for user device 116 based on the comparison of the user credential 156 from user device 116 to the authorized user credential stored within property database 114. For the purposes of this disclosure, a “user credential” is a datum representing an identity, attribute, code, and/or characteristic specific to a user and/or user device. For example, and without limitation, user credential 156 may include a username and password unique to user and/or user device 116. The username and password may include any alpha-numeric character, letter case, and/or special character. As a further example and without limitation, user credential 156 may include a digital certificate.

With continued reference to FIG. in a non-limiting embodiment, processor 102 may manipulate any information of the entirety of this disclosure to be displayed to a user with varying authority or accessibility. Processor 102 may incorporate priority classifiers used to classify low, average, and high classification of authorized users. Users with lower priority classifications detected by processor 102 may allow a limited amount of information (limited accessibility) to be displayed to a user device 116 for viewing by the users with lower priority classification. In a non-limiting embodiment, processor 102 may detect users with high priority classifications and transmit a robust information with full accessibility. Persons of ordinary skill in the art, after viewing the entirety of this disclosure, would appreciate the various amount of information allowed to be viewed for different levels of authority. In a non-limiting embodiment, processor 102 may be used as a security measure for information. For instance, and without limitation, if an authenticated user is a property manager, adaptive data structure 130 may prioritize displaying maintenance records, tenant information, and lease expiration dates. For instance, and without limitation, if a user is a financial analyst, processor 102 may generate adaptive data structure 130 to emphasize market valuation trends, rental income data, and comparative financial metrics. In some embodiments, the prioritization of key data points 128 may include rearranging their display order, highlighting certain key data points 128, or applying filters to present information relevant to the user's context. For example, and without limitation, when accessed by a user with “administrator” credentials, adaptive data structure 130 may display a broader range of key data points 128, including sensitive or restricted information, such as proprietary algorithms or confidential reports.

With continued reference to FIG. 1, in an embodiment, adaptive data structure 130 may be read-only. In another embodiment, adaptive data structure 130 may be writable. In some embodiments, the writable adaptive data structure may require authentication; for instance without limitation, the writable adaptive data structure may be writable only given user credential 156 indicating that a user device 116 that will be modifying adaptive data structure 130 is authorized. In some embodiments, adaptive data structure 130 may include any combination of the above; for instance without limitation, adaptive data structure 130 may include a read-only section 166. For the purposes of this disclosure, a “read-only section” is a portion of an adaptive data structure that is accessible for viewing but cannot be modified or altered by users. For example without limitation, adaptive data structure 130 may include a writable section 168 with limited access. For the purposes of this disclosure, a “writable section” is a portion of an adaptive data structure that allows users to input, edit, or update information. In some embodiments, adaptive data structure 130 may include a writable section 168 with general access, to which any user may be able to input data. Adaptive data structure 130 may include read-only section 166 and generally writable section 168, or the limited access writable section 168 and generally writable section 168, or read-only section 166 and limited access section. The limited access section may be limited to certain users of apparatus 100, or in other words may be generally writable, but only to users of apparatus 100, who may have user credential 156; the users may alternatively be granted user credential 156 by apparatus 100 to update data only when authorized by the system, and otherwise be unable to update adaptive data structure 130. In some embodiments, preventing users from being able to write over an adaptive data structure 130 enables the adaptive data structure 130 to be free from intentional or unintentional corruption or inaccuracy, and enables apparatus 100 to ensure that certain information is always available to users. In some embodiments, writable sections 168 enable apparatus 100 itself or users of apparatus 100 to correct, augment, or update information. For example, and without limitation, an authenticated user with “editor” privileges may gain access to writable sections 168 of adaptive data structure 130 to input or modify information, while a “viewer” role may be restricted to interacting with read-only sections 166.

With continued reference to FIG. 1, in some embodiments, processor 102 may generate adaptive data structure 130 to include read-only sections 166 and/or writable sections 168 as a function of user credential 156, data point groups 150, key data points 128 and/or an access profile. In a non-limiting example, processor 102 may analyze metadata (e.g., data point groups 150, key data points 128, and/or data sets 106) associated with each data field of adaptive data structure 130 and may include read-only sections 166 and/or writable sections 168 to adaptive data structure 130 as a function of the analysis and user credentials 156. For example, and without limitation, each data field within adaptive data structure 130 may be tagged with attributes defining its access level (e.g., “read-only” or “writable”) and any conditions under which its access level may change. In some embodiments, for data fields designated as permanently read-only, processor 102 may lock these data fields, preventing any modifications regardless of user credentials 156. In some embodiments, for data fields where access depends on user credentials 156, processor 102 may authenticate a user and retrieve an access profile of the user. For the purposes of this disclosure, an “access profile” is a set of predefined rules and attributes associated with accessibility to a data structure that is assigned to a user. As a non-limiting example, access profile may include roles, permissions, contextual attributes (e.g., item or data-specific access), scope of user's access to data structure, and the like. In some embodiments, access profile may be retrieved from property database 114 or a user may manually input access profile. In some embodiments, processor 102 may compare access profile against metadata (e.g., data point groups 150, key data points 128, and/or data sets 106) of each data field of adaptive data structure 130 to determine which sections are writable for an authenticated user.

With continued reference to FIG. 1, interactive user interface 120 or GUI may be configured to visually distinguish between read-only section 166 and writable sections 168 of adaptive data structure 130. In some embodiments, read-only sections 166 may be displayed in a static format with visual cues. As a non-limiting example, read-only sections 166 may be displayed in grayed-out text, locked icons, or the absence of interactive elements (e.g., text boxes or dropdown menus), and the like. In some embodiments, writable sections 168 may be visually highlighted using editable fields, active buttons, or color coding to indicate that data in writable sections 168 can be updated or modified. As a non-limiting example, writable sections 168 may include editable elements; for instance, text boxes, dropdown menus, file upload buttons, different color coding, borders, or hover effects.

With continued reference to FIG. 1, in some embodiments, processor 102 or GUI may adjust display of read-only sections 166 and/or writable sections 168 within adaptive data structure 130. For example, and without limitation, if a user with “viewer” credentials logs in, processor 102 may generate adaptive data structure 130 to only display read-only sections 166, suppressing or disabling writable sections 168 entirely. For example, and without limitation, for a user with “editor” credentials, processor 102 may generate adaptive data structure 130 to only display writable sections 168, allowing interaction while maintaining visual and functional separation from the read-only sections 168. In some embodiments, structure training data 164 may be updated as a function of user credential 156, access profile, read-only sections 166 and/or writable sections 168 within adaptive data structure 130, and the like. In some embodiments, structure machine-learning model 162 may generate adaptive data structure 130 with read-only sections 166 and/or writable sections 168 as a function of user credential 156, access profile, and the like.

With continued reference to FIG. 1, apparatus 100 may automate a time-consuming task that typically requires hours of manual searching, improving workflow efficiency for insurance agents, homeowners, and real estate professionals. By scraping from multiple sources and cross-referencing data, apparatus 100 may reduce human error and ensures that all relevant property data is included in the report. The AI-driven apparatus 100 may be designed to handle large-scale operations, meaning it can scrape data for multiple properties simultaneously, enabling insurance companies and real estate firms to process high volumes of properties at once. Apparatus 100 may cross-check historical records to help insurance companies detect inconsistencies or false claims related to property renovations or upgrades.

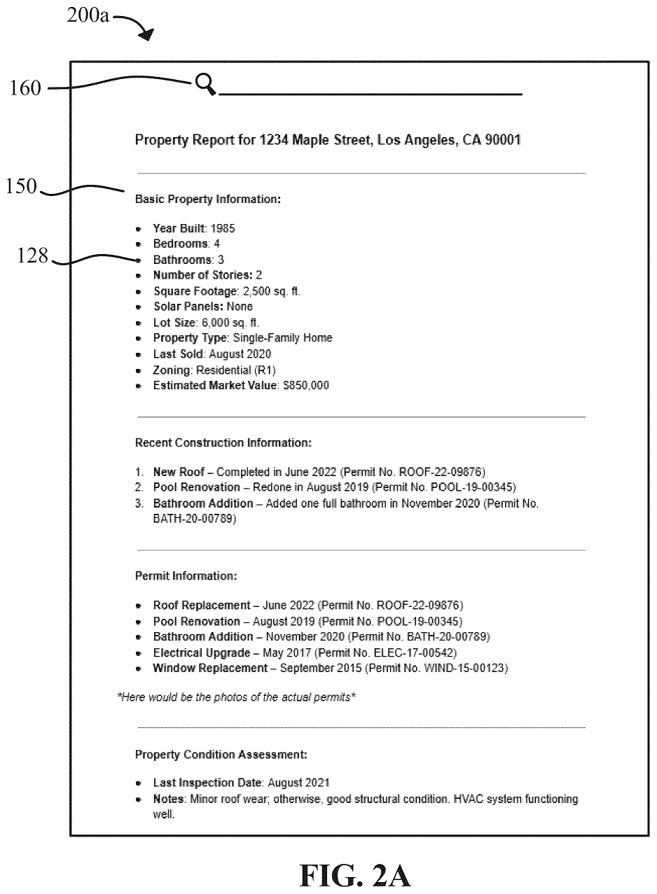

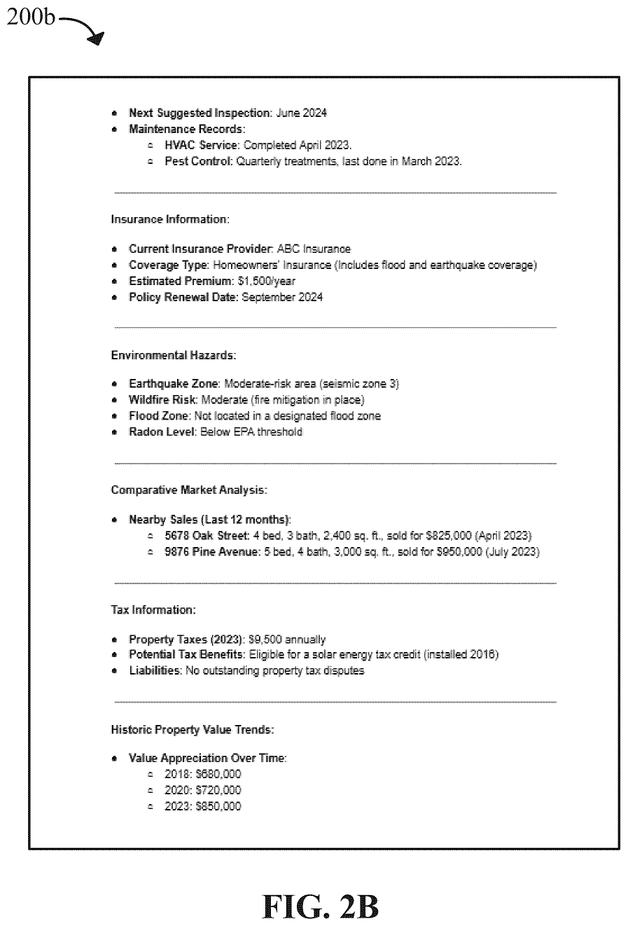

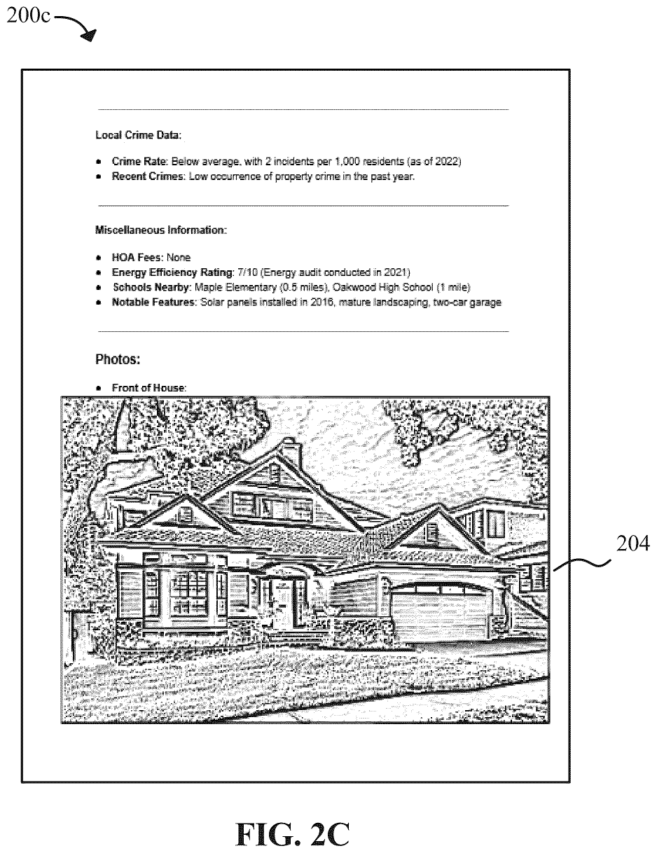

Referring now to FIGS. 2A-C, portions 200a-c of an exemplary adaptive data structure 130 is illustrated. In some embodiments, adaptive data structure 130 may include texts, images 204, graphs, tables, checklists, and the like. In some embodiments, adaptive data structure 130 may include a user input field 160. For example, and without limitation, first portion 200a of adaptive data structure 130 may have a user input field 160. In some embodiments, adaptive data structure 130 may include a plurality of data point groups 150 and associated key data points 128. In a non-limiting example, adaptive data structure 130 may include basic property information (e.g., year built, square footage, lot size, bedrooms, bathrooms), historical renovations and construction activities, permits pulled on the property, including permit numbers and descriptions, liens, encumbrances, and tax records, and additional relevant information (e.g., environmental risks, crime data, and neighborhood comparisons). In a non-limiting example, if an insurance agent needs to verify whether renovations, such as roof repairs and electrical upgrades, were done on a property before issuing a policy, the insurance agent may enter the property address into a user input field 160, then processor 102 may retrieve the entire renovation history and all corresponding permits. In another non-limiting example, if a homeowner wants a proof of renovations to reduce their insurance premiums, the homeowner may use apparatus 100 to pull permits for their home's new roof and pool renovation, which the homeowner can then share with their insurance provider. In another non-limiting example, if an investor is reviewing multiple properties for potential purchase, the investor may input several addresses into user input field 160, obtaining a consolidated view of each property's renovation history, tax assessments, and possible liens or encumbrances.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any data set as described in this disclosure to any output data as described in this disclosure. As a non-limiting illustrative example, input data may include data set 106, key data points 128, data point groups 150, user input 124, and the like. As a non-limiting illustrative example, output data may include key data points 128, data point groups 150, adaptive data structure 130, discrepancy datum 132, notification datum 134, and the like.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to user cohort related to user's location, preference, feedback, role, responsibility, and the like.

Still referring to FIG. 3, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)+P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify data set to one or more clusters and/or categories of features as represented in training data; this may be performed by representing both training data and data set in vector forms, and using one or more measures of vector similarity to identify classifications within training data, and to determine a classification of data set. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify data set as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an data set, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of data set to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{median}}{IQR} .$$

Persons skilled in the art, upon reviewing the entirety of this disclosure, will be aware of various alternative or additional approaches that may be used for feature scaling.

Further referring to FIG. 3, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of data set using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include data set 106, key data points 128, data point groups 150, user input 124, and the like as described above as inputs, key data points 128, data point groups 150, adaptive data structure 130, discrepancy datum 132, notification datum 134, and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

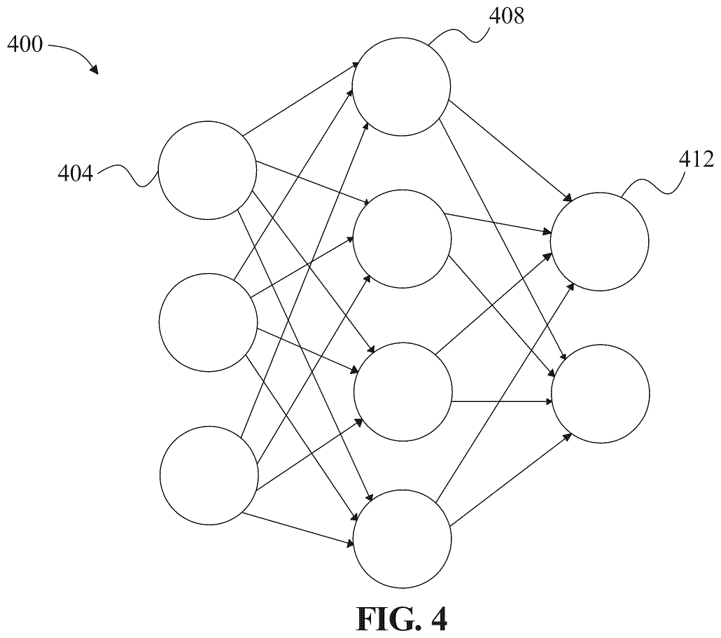

Referring now to FIG. 4 an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

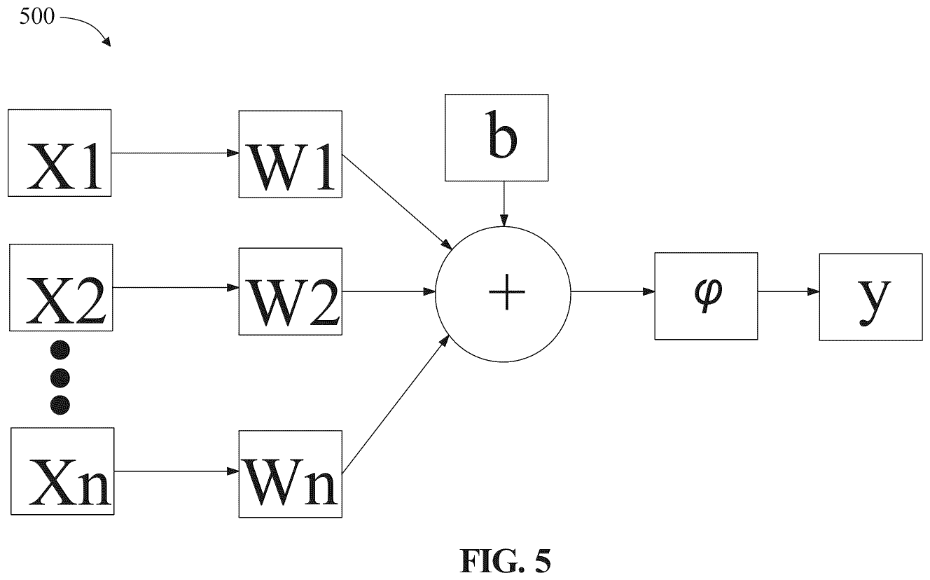

Referring now to FIG. 5 an exemplary embodiment of a node 500 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some α, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

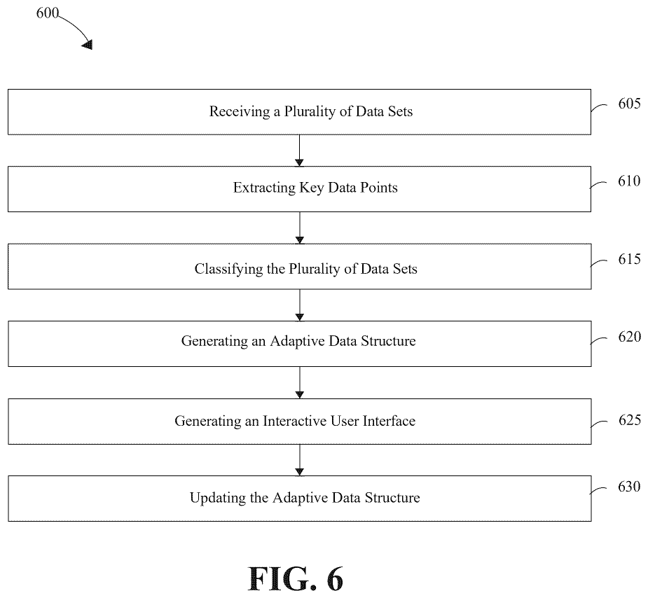

Referring now to FIG. 6, a flow diagram of an exemplary method 600 for adaptive data structure generation is illustrated. Method 600 contains a step 605 of receiving, using at least a processor, a plurality of data sets from one or more data sources. In some embodiments, receiving the plurality of data sets may include receiving the plurality of data sets using a web crawler, wherein the web crawler is configured to retrieve the plurality of data sets from one or more web sources as a function of data retrieval rules. In some embodiments, receiving the plurality of data sets may include updating the data retrieval rules as a function of the user input, wherein the user input may include data feedback and retrieving the plurality of data sets using the web crawler as a function of the updated data retrieval rules. In some embodiments, receiving the plurality of data sets may include identifying a discrepancy datum in the plurality of data sets and generating a notification datum as a function of the discrepancy datum. These may be implemented as referenced to FIGS. 1-5.

With continued reference to FIG. 6, method 600 contains a step 610 of extracting, using at least a processor, key data points from a plurality of data sets, wherein extracting the key data points includes generating natural language training data comprising industry verbiages, training a natural language processing module using the natural language training data and extracting the key data points using the trained natural language processing module. In some embodiments, extracting the key data points may include extracting an image-based data point of the key data points from image data of the plurality of data sets using a machine vision module. In some embodiments, extracting the key data points may include extracting a text-based data point of the key data points from image data of the plurality of data sets using an optical character recognition. These may be implemented as referenced to FIGS. 1-5.

With continued reference to FIG. 6, method 600 contains a step 615 of classifying, using at least a processor, a plurality of data sets into one or more data point groups as a function of key data points. In some embodiments, classifying the plurality of data sets into the one or more data point groups may include generating classification training data comprising exemplary data sets correlated to exemplary data point groups, training a group classifier using the classification training data and classifying the plurality of data sets using the trained group classifier. These may be implemented as referenced to FIGS. 1-5.

With continued reference to FIG. 6, method 600 contains a step 620 of generating, using at least a processor, an adaptive data structure as a function of one or more data point groups. This may be implemented as referenced to FIGS. 1-5.

With continued reference to FIG. 6, method 600 contains a step 625 of generating, using at least a processor, an interactive user interface displaying an adaptive data structure, wherein the interactive user interface includes one or more event handlers, wherein the one or more event handlers are configured to receive a user input through a user input field. These may be implemented as referenced to FIGS. 1-5.

With continued reference to FIG. 6, method 600 contains a step 630 of updating, using at least a processor, an adaptive data structure as a function of a user input. In some embodiments, updating the adaptive data structure may include authenticating a user credential of a user and updating the adaptive data structure as a function of the user credential by prioritizing at least a portion of the key data points in the adaptive data structure. In some embodiments, generating the adaptive data structure may include generating a read-only section and a writable section of the adaptive data structure as a function of the user credential. In some embodiments, updating the adaptive data structure may include generating structure training data, wherein the structure training data may include exemplary key data points and exemplary user credentials correlated to exemplary adaptive data structures, training a structure machine-learning model using the structure training data and generating the adaptive data structure using the trained structure machine-learning model. These may be implemented as referenced to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

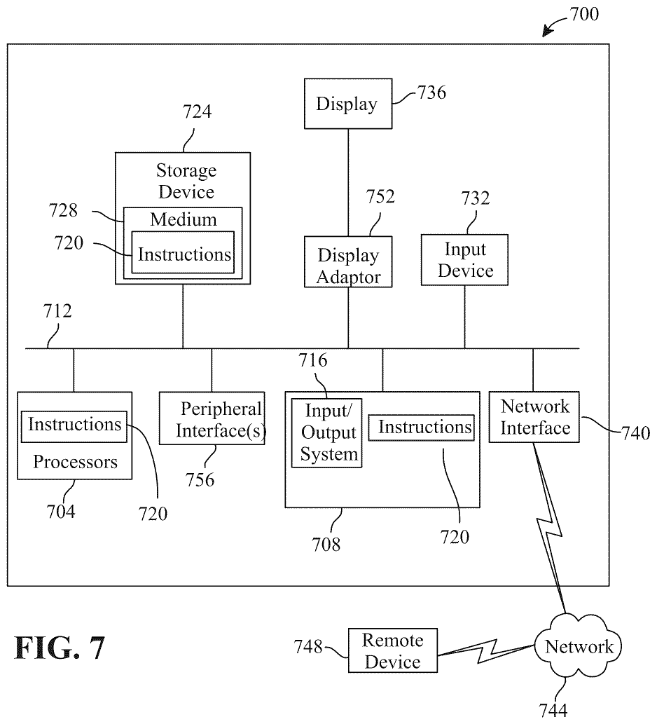

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and memory 708 that communicate with each other, and with other components, via a bus 712. Bus 712 may include any of several types of bus structures including, but not limited to, memory bus, memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display 736. Examples of a display device include, but are not limited to, a liquid crystal display (LCD), a cathode ray tube (CRT), a plasma display, a light emitting diode (LED) display, and any combinations thereof. Display adapter 752 and display 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention. Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for adaptive data structure generation, the apparatus comprising:
at least a processor; and
a memory communicatively connected to the at least a processor, wherein the memory contains instructions configuring the at least a processor to:
receive a plurality of data sets from one or more data sources;
generate a web crawler configured to search and detect one or more data patterns related to the plurality of data sets and identify a relevancy for each of the plurality of data sets by generating a relevancy score for each of the plurality of data sets;
generate natural language training data from the plurality of data sets, the relevancy score for each of the plurality of data sets and the detected one or more patterns related to the plurality of data sets, the natural language training data comprising industry verbiages;
train, using the natural language training data, a natural language processing module,
extract, using the trained natural language processing module, key data points from the plurality of data sets and the relevancy score for each of the plurality of data sets;
classify the plurality of data sets into one or more data point groups as a function of the key data points and the relevancy score for each of the plurality of data sets;
generate an adaptive data structure as a function of the one or more data point groups;
generate an interactive user interface displaying the adaptive data structure, wherein the interactive user interface comprises one or more event handlers, wherein the one or more event handlers are configured to receive a user input through a user input field;
update the adaptive data structure as a function of the user input.

2. The apparatus of claim 1, wherein receiving the plurality of data sets comprises receiving the plurality of data sets using a web crawler, wherein the web crawler is configured to retrieve the plurality of data sets from one or more web sources as a function of data retrieval rules.

3. The apparatus of claim 2, wherein receiving the plurality of data sets comprises:
updating the data retrieval rules as a function of the user input, wherein the user input comprises data feedback; and
retrieving the plurality of data sets using the web crawler as a function of the updated data retrieval rules.

4. The apparatus of claim 1, wherein receiving the plurality of data sets comprises: identifying a discrepancy datum in the plurality of data sets; and
generating a notification datum as a function of the discrepancy datum.

5. The apparatus of claim 1, wherein extracting the key data points comprises extracting an image-based data point of the key data points from image data of the plurality of data sets using a machine vision module.

6. The apparatus of claim 1, wherein extracting the key data points comprises extracting a text-based data point of the key data points from image data of the plurality of data sets using an optical character recognition.

7. The apparatus of claim 1, wherein classifying the plurality of data sets into the one or more data point groups comprises:
generating classification training data comprising exemplary data sets correlated to exemplary data point groups;
training a group classifier using the classification training data; and
classifying the plurality of data sets using the trained group classifier.

8. The apparatus of claim 1, wherein updating the adaptive data structure comprises:
authenticating a user credential of a user; and
updating the adaptive data structure as a function of the user credential by prioritizing at least a portion of the key data points in the adaptive data structure.

9. The apparatus of claim 8, wherein generating the adaptive data structure comprises generating a read-only section and a writable section of the adaptive data structure as a function of the user credential.

10. The apparatus of claim 1, wherein updating the adaptive data structure comprises: generating structure training data, wherein the structure training data comprises exemplary key data points and exemplary user credentials correlated to exemplary adaptive data structures;
training a structure machine-learning model using the structure training data; and
generating the adaptive data structure using the trained structure machine-learning model.

11. A method for adaptive data structure generation, the method comprising:
receiving, using at least a processor, a plurality of data sets from one or more data sources;
generating, using the at least a processor, a web crawler configured to search and detect one or more data patterns related to the plurality of data sets and identify a relevancy for each of the plurality of data sets by generating a relevancy score for each of the plurality of data sets;
generating, using the at least a processor, natural language training data from the plurality of data sets, the relevancy score for each of the plurality of data sets and the detected one or more patterns related to the plurality of data sets, the natural language training data comprising industry verbiages;
training, using the at least a processor, a natural language processing module with the natural language training data;
extracting, using the trained natural language processing module, key data points from the plurality of data sets and the relevancy score for each of the plurality of data sets,
classifying, using the at least a processor, the plurality of data sets into one or more data point groups as a function of the key data points and the relevancy score for each of the plurality of data sets;
generating, using the at least a processor, an adaptive data structure as a function of the one or more data point groups;
generating, using the at least a processor, an interactive user interface displaying the adaptive data structure, wherein the interactive user interface comprises one or more event handlers, wherein the one or more event handlers are configured to receive a user input through a user input field; and
updating, using the at least a processor, the adaptive data structure as a function of the user input.

12. The method of claim 11, wherein receiving the plurality of data sets comprises receiving the plurality of data sets using a web crawler, wherein the web crawler is configured to retrieve the plurality of data sets from one or more web sources as a function of data retrieval rules.

13. The method of claim 12, wherein receiving the plurality of data sets comprises:
updating the data retrieval rules as a function of the user input, wherein the user input comprises data feedback; and
retrieving the plurality of data sets using the web crawler as a function of the updated data retrieval rules.

14. The method of claim 11, wherein receiving the plurality of data sets comprises:
identifying a discrepancy datum in the plurality of data sets; and
generating a notification datum as a function of the discrepancy datum.

15. The method of claim 11, wherein extracting the key data points comprises extracting an image-based data point of the key data points from image data of the plurality of data sets using a machine vision module.

16. The method of claim 11, wherein extracting the key data points comprises extracting a text-based data point of the key data points from image data of the plurality of data sets using an optical character recognition.

17. The method of claim 11, wherein classifying the plurality of data sets into the one or more data point groups comprises:
generating classification training data comprising exemplary data sets correlated to exemplary data point groups;
training a group classifier using the classification training data; and
classifying the plurality of data sets using the trained group classifier.

18. The method of claim 11, wherein updating the adaptive data structure comprises:
authenticating a user credential of a user; and
updating the adaptive data structure as a function of the user credential by prioritizing at least a portion of the key data points in the adaptive data structure.

19. The method of claim 18, wherein generating the adaptive data structure comprises generating a read-only section and a writable section of the adaptive data structure as a function of the user credential.

20. The method of claim 11, wherein updating the adaptive data structure comprises:
generating structure training data, wherein the structure training data comprises exemplary key data points and exemplary user credentials correlated to exemplary adaptive data structures;
training a structure machine-learning model using the structure training data; and
generating the adaptive data structure using the trained structure machine-learning model.
